(19) United States
(12) Patent Application Publication
(10) Pub. No.: US 2023/0022009 A1
(43) Pub. Date: Jan. 26, 2023

(54) Microspeaker Enclosure Including Block Formed of Porous Particles

(71) Applicant: EM-TECH Co., Ltd., Gyeongsangnam-do (KR)

(72) Inventors: Yong Hee Oh, Gyeongsangnam-do (KR); Jae Hwa Lim, Gyeongsangnam-do (KR)

(21) Appl. No.: 17/869,338

(22) Filed: Jul. 20, 2022

(30) Foreign Application Priority Data
Jul. 21, 2021 (KR) 10-2021-0095801

(51) Int. Cl. H04R 1/28; H04R 1/02

(52) U.S. Cl. CPC H04R 1/288; H04R 1/021; H04R 2499/11; H04R 2201/003

(57) ABSTRACT

The present disclosure provides a microspeaker enclosure including a block formed of a porous material. The microspeaker enclosure includes a microspeaker, an enclosure case in which the microspeaker is mounted, the enclosure case including a back volume communicating with the microspeaker, and a porous block installed in the back volume and prepared by mixing first porous particles having excellent adsorption capacity of nitrogen or oxygen and second porous particles having a porosity of 50% or more.

### TECHNICAL FIELD

The present disclosure relates to a microspeaker enclosure including a block formed of a porous material.

### BACKGROUND

A microspeaker is provided in a portable device, etc. to generate sound. With recent developments of mobile devices, the microspeaker has been used for various devices. In particular, the latest mobile device tends to have a light weight, small size, and slim shape to facilitate portability, and accordingly, the microspeaker mounted in the mobile device is required to have a small size and slim shape.

However, in the case of a microspeaker having a small size and slim shape, an area of a diaphragm decreases, and a size of a resonance space in which the sound generated by vibration of the diaphragm is resonated and amplified also decreases, as a result of which a sound pressure level (SPL) decreases. Such decrease in the sound pressure level is particularly pronounced at low frequencies. There has been developed a technology of improving a low frequency sound pressure level and reducing total harmonic distortion (THD) by arranging an air adsorbent, which is a porous material, in a resonance space, so that the air adsorbent adsorbs air molecules and defines a virtual acoustic space, to enhance a low frequency sound pressure level.

FIG. 1 is a view illustrating a microspeaker enclosure filled with a porous material according to the related art. According to the related art, a microspeaker 1 is mounted on enclosure cases 2 and 3, and a back volume 4 is provided between the upper and lower enclosure cases 2 and 3. The back volume 4 communicates with a back hole of the microspeaker 1 and is filled with porous particles 5. As the porous particles 5 adsorb air molecules, a virtual acoustic space is formed, thus achieving an effect of expanding the back volume 4.

However, the microspeaker enclosure filled with a porous material according to the related art has a disadvantage in that noise occurs when the microspeaker 1 generates a sound or the porous particles 5 vibrate due to an impact applied to the enclosure.

In order to solve the disadvantage, there have been disclosed technologies of making porous particles a block and installing the block in an enclosure. However, if the porous particles are formed as a block, air may not be circulated to the particles located inside the porous particle block, and thus, the performance of absorption of air may gradually decrease as the size of the block increases.

### SUMMARY

An object of the present disclosure is to provide a microspeaker enclosure including a porous block, which does not reduce an air adsorption rate and an air circulation rate of porous particles, while forming the porous particles as a block.

According to an aspect of the present disclosure for achieving the above objects, there is provided a microspeaker enclosure including a block formed of a porous material including: a microspeaker, an enclosure case in which the microspeaker is mounted, the enclosure case including a back volume communicating with the microspeaker, and a porous block installed in the back volume and prepared by mixing first porous particles having excellent adsorption capacity of nitrogen or oxygen and second porous particles having a porosity of 50% or more.

The first porous particles may include any one or more of zeolite, activated carbon, and MOFs.

The second porous particles may include any one or more of aerogel, porous silica, and MOFs.

The porous block may include a binder for binding the first porous particles and the second porous particles.

The porous block may be in a shape in which a tape or film is attached to a surface thereof together.

The porous block may have a reinforcing material provided therein.

At least one porous block may be disposed in the resonance space.

In the microspeaker enclosure including a block formed of a porous material provided in the present disclosure, a block is manufactured by mixing the second porous particles having a porosity of 50% or more to have a good air circulation rate with the first porous particles having high nitrogen and oxygen adsorption power, whereby the porous material may be formed as a block without degrading an air adsorption power of the first porous particles.

### BRIEF DESCRIPTION OF THE DRAWINGS

FIG. 1 is a view illustrating a microspeaker enclosure filled with a porous material according to the related art;

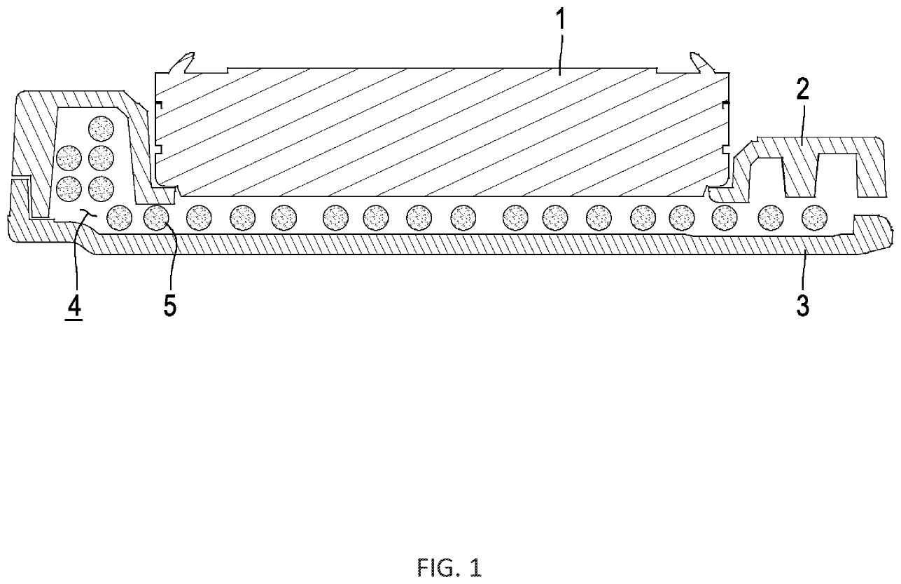

FIG. 2 is an exploded view of a microspeaker enclosure including a block formed of a porous material according to an embodiment of the present disclosure;

FIG. 3 is a cross-sectional view of a microspeaker enclosure including a block formed of a porous material according to a first embodiment of the present disclosure;

FIG. 4 is a cross-sectional view illustrating an example of a block provided in a microspeaker enclosure including a block formed of a porous material according to the first embodiment of the present disclosure;

FIG. 5 is a cross-sectional view illustrating another example of a block provided in a microspeaker enclosure including a block formed of a porous material according to an embodiment of the present disclosure; and

FIG. 6 is a cross-sectional view of a microspeaker enclosure including a block formed of a porous material according to a second embodiment of the present disclosure.

### DETAILED DESCRIPTION

Hereinafter, the present disclosure will be described in more detail with reference to the drawings.

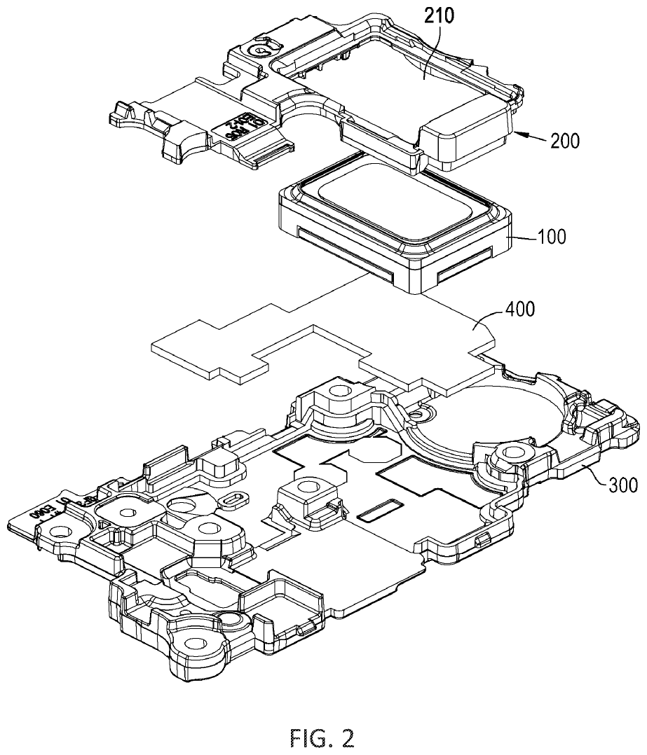

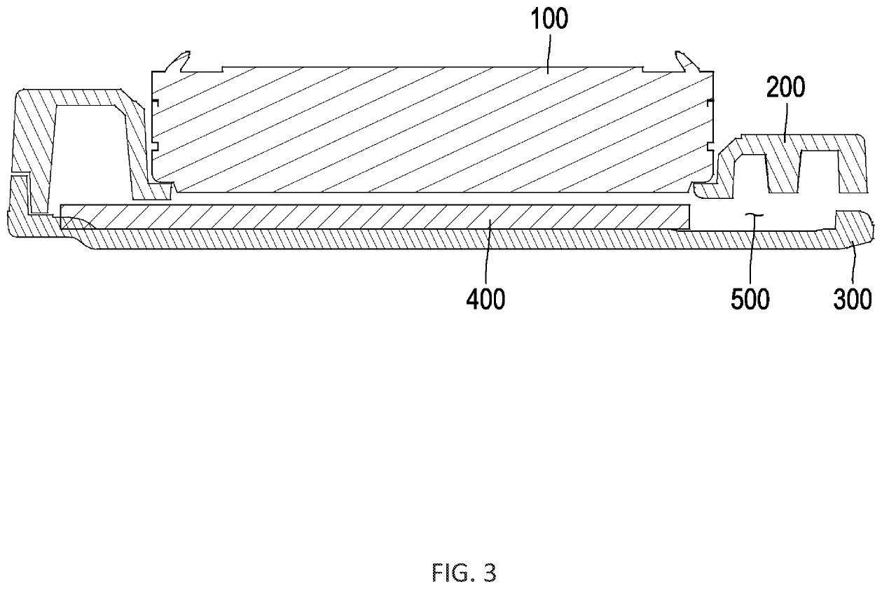

FIG. 2 is an exploded view of a microspeaker enclosure including a block formed of a porous material according to a first embodiment of the present disclosure, and FIG. 3 is a cross-sectional view of a microspeaker enclosure including a block formed of a porous material according to the first embodiment of the present disclosure.

A microspeaker enclosure including a block formed of a porous material according to the first embodiment of the present disclosure includes a microspeaker 100, enclosure cases 200 and 300, and a porous block 400. The enclosure cases 200 and 300 include an upper enclosure case 200 and a lower enclosure case 300 coupled to form a back volume 500 therein. The upper enclosure case 200 includes a microspeaker accommodation portion 210 so that the microspeaker 100 may be mounted therein. A backhaul (not shown) of the microspeaker 100 communicates with the back volume 500 through the microspeaker accommodation portion 210.

The porous block 400 is installed in the back volume 500 in a state in which porous particles are made into a block. The porous block 400 is manufactured by mixing first porous particles having excellent adsorption capacity of nitrogen or oxygen, which accounts for most of the air, and second porous particles having a porosity of 50% or more, and then forming a block.

As the first porous particles, particles having a high adsorption rate of nitrogen or oxygen, such as zeolite, activated carbon, and MOFs used in the related art, are used. The porous particles used to improve acoustic properties by functioning as a virtual back volume are mainly zeolite, and a diameter of zeolite grains up to 300 μm to 500 μm has air adsorption properties that improve acoustic performance. However, although manufactured in the same composition ratio, if the diameter of the zeolite grains is 500 μm or more, the air adsorption properties that improve the acoustic performance start to degrade. The reason why the acoustic performance improvement characteristics are degraded according to the size of the particles is because, air circulation should be made to the inside of the most porous particles that are filled in accordance with an operating speed of the microspeaker but air circulation becomes difficult and the air adsorption performance of porous particles gradually decreases when the diameter of the grains is equal to or greater than 500 μm. For example, if a block of 1 cm³ is formed of zeolite, the zeolite forming the block has no ability to improve acoustic properties.

Therefore, in order to help air circulation to the first porous particles, a material having a high air circulation capacity should be mixed. In the present disclosure, as the second porous particle, a material having a porosity of 50% or more should be used. As the second porous particles, aerogel, porous silica, and MOFs may be used alone or in combination.

In addition, a material having adhesion, that is, a binder, may be added to the porous block 400 to form a block by binding the first porous particles and the second porous particles to each other. There is no restriction on the shape of the porous block 400, and the porous block 400 may have various shapes, such as a polyhedron or a shape corresponding to the back volume 500.

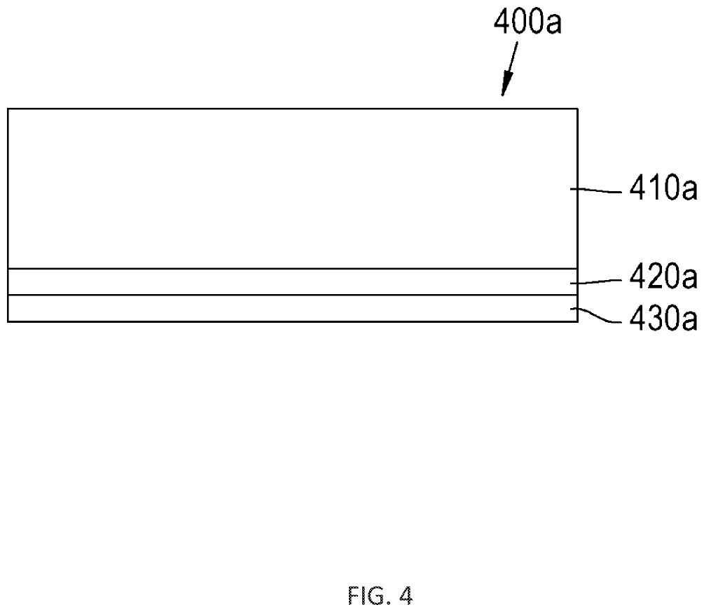

FIG. 4 is a cross-sectional view illustrating an example of a block provided in the microspeaker enclosure including a block formed of a porous material according to the first embodiment of the present disclosure.

A film 430a may be attached to a porous block body 410a of the porous block 400a using a tape 420a to enhance adhesion, strength, or durability. In this case, only the tape 420a may be attached without the film 430a.

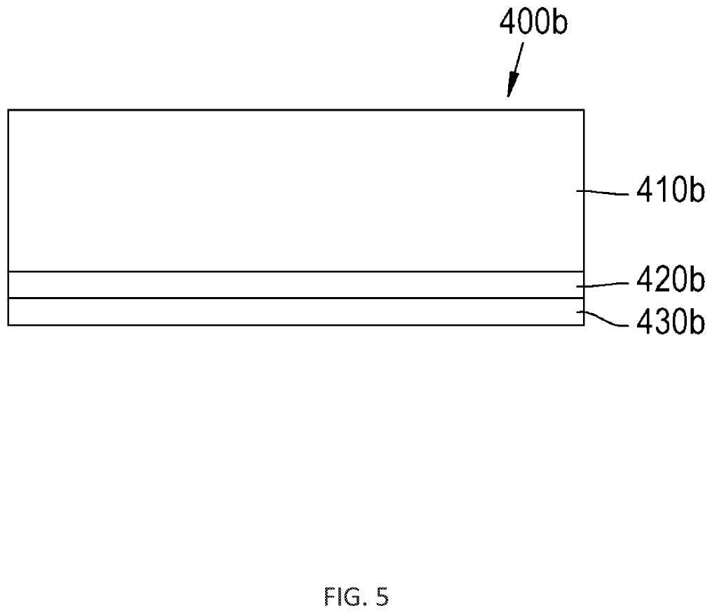

FIG. 5 is a cross-sectional view illustrating another example of a block provided in a microspeaker enclosure including a block formed of a porous material according to an embodiment of the present disclosure.

A reinforcing material 420b for reinforcing durability like a film is inserted between a first porous block body 410b and a second porous block body 430b of a porous block 400b to reinforce strength.

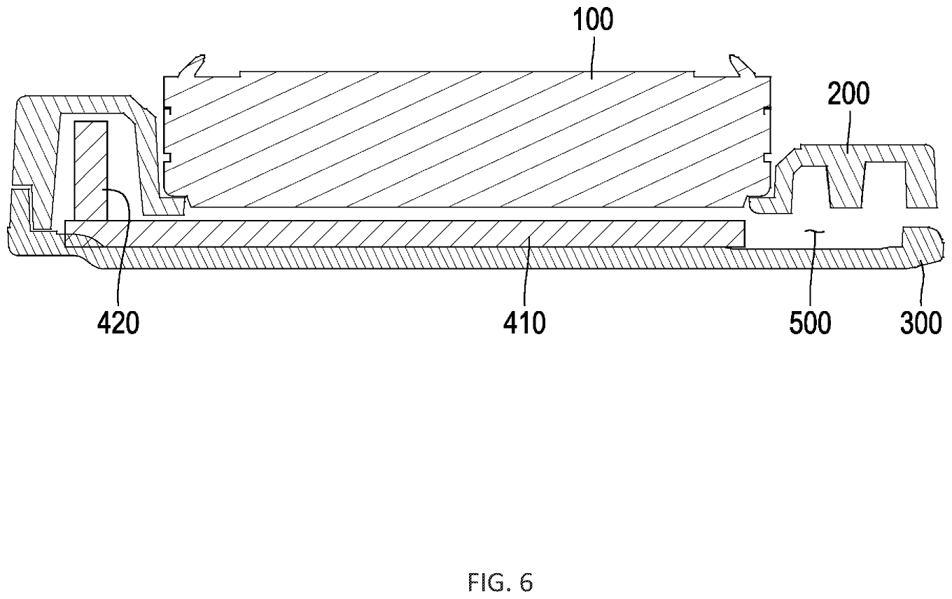

FIG. 6 is a cross-sectional view of a microspeaker enclosure including a block formed of a porous material according to a second embodiment of the present disclosure.

In the microspeaker enclosure including a block formed of a porous material according to the second embodiment of the present disclosure, a first porous block 410 and a second porous block 420 are installed in a back volume 500. That is, two or more porous blocks 410 and 420 may be disposed in the back volume 500.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A microspeaker enclosure including a block formed of a porous material, the microspeaker enclosure comprising:
a microspeaker;
an enclosure case in which the microspeaker is mounted, the enclosure case including a back volume communicating with the microspeaker; and
a porous block installed in the back volume and prepared by mixing first porous particles having adsorption capacity of nitrogen or oxygen and second porous particles having a porosity of 50% or more.

2. The microspeaker enclosure of claim 1, wherein the first porous particles include zeolite and/or activated carbon and/or MOFs.

3. The microspeaker enclosure of claim 1, wherein the second porous particles include aerogel and/or porous silica and/or MOFs.

4. The microspeaker enclosure of claim 1, wherein the porous block includes a binder for binding the first porous particles and the second porous particles.

5. The microspeaker enclosure of claim 1, wherein the porous block includes a tape or film attached to a porous block body of the porous block.

6. The microspeaker enclosure of claim 1, wherein the porous block comprises a reinforcing material.

7. The microspeaker enclosure of claim 1, wherein at least one porous block is disposed in a resonance space.
